(19) United States
(12) Patent Application Publication
(10) Pub. No.: US 2013/0054451 A1
(43) Pub. Date: Feb. 28, 2013

(54) METHOD AND SYSTEM OF DEFERRED PRESENTMENT(S) FOR THE PURCHASE OF GOODS AND/OR SERVICES

(71) Applicants: Anthony S. Maley, Highlands Ranch, CO (US); John Dorsey, Englewood, CO (US)

(72) Inventors: Anthony S. Maley, Highlands Ranch, CO (US); John Dorsey, Englewood, CO (US)

(73) Assignee: ELECTRONIC PAYMENT SYSTEMS, LLC, Englewood, CO (US)

(21) Appl. No.: 13/215,105

(22) Filed: Aug. 22, 2011

(51) Int. Cl. G06Q 40/00

(52) U.S. Cl. 705/40

(57) ABSTRACT

Methods and systems of deferred presentment for the purchase of goods and/or services. One arrangement includes a Point Of Sale (POS) device combined with a check reader and/or imaging device for receiving and storing check instrument data (e.g., amount, date of presentment, routing number) and customer identifying information (e.g., a customer PIN). A database of previous check writing experience and activity may be accessed to determine whether or not a current check instrument is to be verified. Choosing to proceed with execution of a verified check instrument may include a guarantee component that serves to credit a merchant or other party with funds in the event that a check instrument fails to clear a bank.

### FIELD OF THE INVENTION

The present invention relates to systems and methods for deferred presentments for the purchase of goods and/or services. More particularly, the invention relates to systems and methods for non-credit based approvals and payment for goods and/or services via deferred presentments of Automated Clearing House (ACH) transactions.

### BACKGROUND OF THE INVENTION

For a merchant such as a dealer, storekeeper or other retailer, getting paid for the goods and/or services they provide is the life's blood of their business. Over time, the need to be flexible in the manner by and with which merchants are paid has continued to grow. While bartering was once a standard method of payment in goods and services transactions, it was replaced by currencies and eventually checks which are in essence a promise to pay. Eventually, banks began the practice of making loans, and credit cards came into the picture in the 1950's.

While these varying and expanding forms of negotiable payment mediums provided merchants and customers with increased options, the need to be flexible on the part of merchants or other parties extending goods and/or services did not stop there. In lieu of developing additional methods or mediums of payment which may otherwise have been prohibitive on a number of levels, merchants became more creative with the existing resources available to them. For instance, mixed payment variations such as paying part in cash and part by credit card became abundant. Stated otherwise, splitting the payments to constitute full satisfaction of a purchase has become a fairly common practice.

Some merchants found that cash or credit is not always available, or that their customers could not afford to pay the entire amount at the time of purchase. As a result, some merchants began accepting portioned payments via post-dated checks. However, checks are negotiable when tendered i.e., regardless of the date written on the check, a person can take it to a bank and present for payment. Technically, a bank would be obligated to honor a “post-dated” check even if tendered before the date written on the check. Further, in many states it is unlawful to write a check knowing that you do not have sufficient funds to cover the amount of the check. While people can in some circumstances take a check to a bank and present (e.g., tender) the check for payment regardless of the date written on the check, merchants may in some situations agree to hold the check until the specific post-date or date of presentment indicated on the check (i.e., merchants may agree to engage in a “deferred presentment transaction”). However, the merchant is taking a risk that the customer will have funds in the account to cover the amount of the check on the date of presentment. Furthermore, merchants typically also have to account for, manage, and negotiate the checks which are labor intensive activities that often require unwarranted diligence.

### SUMMARY OF THE INVENTION

To at least partially alleviate or resolve many of the aforementioned issues and other complications related to deferred presentment transactions, disclosed herein are methods and systems of deferred presentment(s) for the purchase of goods and/or services. For example, the methods and systems may include the implementation of a process that converts a plurality of check instruments into Automated Clearing House (ACH) transactions. The first check instrument may be checked against a database of check writers with known experience and activity for verification, and the subsequent check instruments may be stored for deferred presentment based on the agreed date(s). All data from the check instruments may be parsed into a form prescribed by the National Automated Clearing House (NACHA). The ACH transactions may then be processed through a bank such as an FDIC insured bank. Check instruments that fail to clear the presentment may be reviewed for inclusion in a guarantee component of the program and if qualified the merchant may be paid regardless of the presentment clearing. Check instruments that clear the presentment are forwarded without further review by the merchant.

In any case, all check instrument data may be parsed or otherwise converted into a form prescribed by any appropriate regulations or applicable regulatory body (e.g., NACHA which manages the development, administration, and governance of the ACH Network). The ACH transactions may be processed through one or more banks (e.g.,

FDIC insured banks) for presentment of the check instruments to the banks. Check instruments that clear the presentment may result in funds being forwarded (e.g., without further review) directly or indirectly to the merchant (e.g., to a bank or other financial institution associated with the merchant). Check instruments that fail to clear the presentment may be reviewed to determine if the merchant qualities for a guarantee component. If qualified, the merchant may be still be paid despite the failure of the check instrument to clear. In this regard, the systems and methods disclosed herein allow for non-credit based approval and payment of goods and/or services via deferred presentments of ACH transactions.

In one embodiment, a method for facilitating a deferred presentment transaction between parties is provided. The method may include the steps of: first inputting, at a receiving platform, first check instrument data relating to a first check instrument presented by a first party to a second party as part of a deferred presentment transaction, the data comprising at least first party identification data and a first date of presentment; accessing, via at least one communications network, a database of records for parties that have previously presented check instruments to other parties; presenting, on a user interface associated with the receiving platform and based on the accessing step, an indication specifying whether or not the deferred presentment transaction is validated; second inputting, at the receiving platform, second check instrument data relating to a second check instrument presented by the first party to the second party as part of the deferred presentment transaction, the second check instrument data comprising at least a second date of presentment; storing the first check instrument data and the second check instrument data on a storage medium associated with the receiving platform; and transmitting, over a data transmission vehicle, at least the first check instrument data and the second check instrument data to a third-party storage entity during a batch upload process.

According to another embodiment, a method is provided for use in facilitating a deferred presentment transaction between parties. The method may include accessing, at a processing platform, data corresponding to at least one check instrument presented by a first party to a second party as part of a deferred presentment transaction, wherein the data comprises at least an amount to be paid from the first party to the second party and a date of presentment; determining whether a current date matches the date of presentment of the at least one check instrument; responsive to the current date failing to match the date of presentment of the at least one check instrument, re-performing the determining step; responsive to the current date matching the date of presentment, parsing the check instrument data into a format prescribed by NACHA; transmitting the parsed check instrument data to a financial institution of the first party for execution of the at least one check instrument; determining whether the at least one check instrument has cleared the financial institution of the first party; and transmitting funds relating to the at least one check instrument to the second party via an ACH distribution.

One or more systems for carrying out such methods is also provided.

Numerous additional features and advantages of the present disclosure will become apparent to those skilled in the art upon consideration of the embodiment descriptions provided hereinbelow.

### BRIEF DESCRIPTION OF THE DRAWINGS

FIG. 1 is a flow diagram of a method for facilitating a deferred presentment transaction for the purchase of goods and/or services

FIG. 2 illustrates a method and system for facilitating deferred presentments for the purchase of goods and/or services.

FIG. 3 illustrates a method and system for facilitating deferred presentments for the purchase of goods and/or services.

FIG. 4 illustrates a method and system for facilitating deferred presentments for the purchase of goods and/or services.

FIG. 5 illustrates a method and system for facilitating deferred presentments for the purchase of goods and/or services.

FIG. 6 is a schematic illustration of a system for use in facilitating deferred presentment transactions between parties.

FIG. 7 is a flow diagram of a method for use in facilitating deferred presentment transactions.

FIG. 8 is flow diagram of a method for use in facilitating deferred presentment transactions.

FIG. 9 is a schematic illustration of a system for use in facilitating deferred presentment transactions between parties.

### DETAILED DESCRIPTION

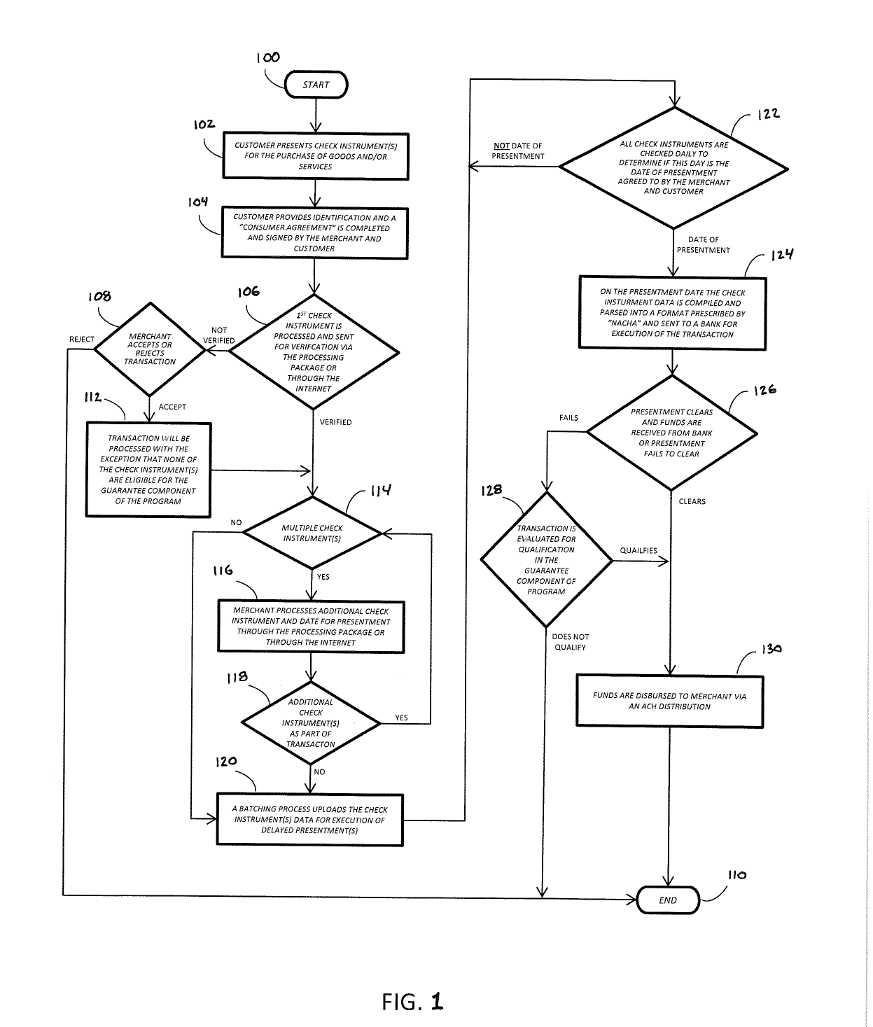

FIG. 1 illustrates a method for facilitating deferred presentment transactions in accordance with one embodiment of the present invention. The steps outlined in FIG. 1 are demonstrative and intended to illustrate an embodiment of the invention and not an exclusive implementation of the method. Some of the steps illustrated in FIG. 1 are only implemented under certain circumstances based on certain results of a prior decision, and are included to provide a broader overview of the method. Some of the illustrated steps may be combined, separated, eliminated, or in certain circumstances performed in a different order than those illustrated.

The method may start at step 100 with an agreement (e.g., a written agreement) between a customer (e.g., a purchaser of goods and/or services) and a merchant wherein the parties wish to purchase/sell goods and/or services, and where a method and system of deferred presentment(s) for the purchase of the goods and/or services is utilized for satisfaction of payment for the goods/services. By way of example, the merchant and customer may agree on price, e.g., including but not limited to the exact cost for the goods and/or services, appropriate tax (sales tax or otherwise as dictated by the local laws and tax authorities), service fees, and program participation fees, if any, as well as the number and amount of deferred presentments, and the date of each deferred presentment. At step 102, the customer presents a check instrument or a series of check instruments for the purchase 102 and at step 104 the merchant may prepare a consumer agreement for the transaction including the information relating to the deferred presentments discussed above. With the completed consumer agreement filled out and signed or otherwise verified by the customer, the merchant may submit the first check instrument for processing at step 106. This step 106 of the illustrative method of FIG. 1 may determine the verification status of the check instrument via a third-party database of known check writing experience and activity for individuals. In the event the check instrument is “not verified” (e.g., due to negative check writing history), the merchant may have the option to accept or reject the transaction at step 108. If the merchant rejects the transaction, the process is terminated 110.

If the merchant accepts the transaction despite non-verification of the check instrument, the merchant may do so with the understanding that the check instrument(s) associated to this transaction are not eligible for a guarantee component of the program at step 112. At this time the “not verified” variation of the decision from step 106 wherein the merchant decided to accept the transaction returns to the path of a “verified” check instrument.

In the event the check instrument is “verified”, or where the merchant accepts the check instrument absent the guarantee component of the program, the next determination is related to how many check instruments are to be processed in the transaction. Thus, step 114 of the illustrative method of FIG. 1 determines if an additional check instrument needs to be processed to complete the transaction. If there is only one check instrument, the transaction is complete and the process may move to the batching step 120. If additional check instruments are part of the transaction the merchant may process the additional check instrument(s) with the date(s) of deferred presentment at step 116. This sub-process 116 of the illustrative method of FIG. 1 may include a determination at step 118 to determine if this is the final check instrument related to the transaction or if additional check instruments need to be processed. If all check instruments that are a part of the transaction have been processed, the transaction is complete and the process moves to await the batching process 120. If there are additional check instruments to be processed, the illustrative method returns to step 114 and may repeat steps 114, 116, and 118 until all check instruments that are related to the transaction are processed.

Once all check instruments are processed through the system, the next step may include a batching step 120 via upload(s) of data and check instrument image(s) for execution of the deferred presentment(s). In one aspect, not all check instruments are submitted on the day of the transaction. This creates the need for a determination if the current day is the day of presentment. Therefore, the next step in the illustrative method of FIG. 1 is a determination 122 if the current day is the intended date of presentment. If it is not the date of presentment, the process is returned to the path that brought it to the determination point of step 122 for processing on the next day (e.g., the next business day). The return to the process could result once again in a return to the path that brought it to the determination point of step 122 for processing on the next day.

This step 122 is repeated until it is the date of presentment for a particular check instrument. On the date of presentment the data from the check instrument(s) are compiled and parsed into a format prescribed by the governing body of the ACH Network (NACHA) and sent to a bank for execution of the presentment at step 124.

The next step in the illustrative method of FIG. 1 is a determination 126 if the presentment clears and the funds are received by the processor from the bank 126. In the event of a failure to clear, the transaction is evaluated at step 128 for qualification in the guarantee component of the program. If the transaction does not qualify for the guarantee component, the transaction ends at block 110. If the transaction qualifies for the guarantee component of the program the transaction returns to the path as if the presentment had cleared (see the “CLEARS” path of the determination made at step 126) and funds were received from the bank. If the transaction clears the funds are then distributed to the merchant at step 130 via an ACH disbursement, less fees (if any) associated with and contractually agreed to for the transaction. If this was the last presentment of check instrument data in the transaction the process simply ends 110. If there is additional check instrument data processing through the method at step 122, the method continues until all check instrument data is processed and at that point the process ends at step 110.

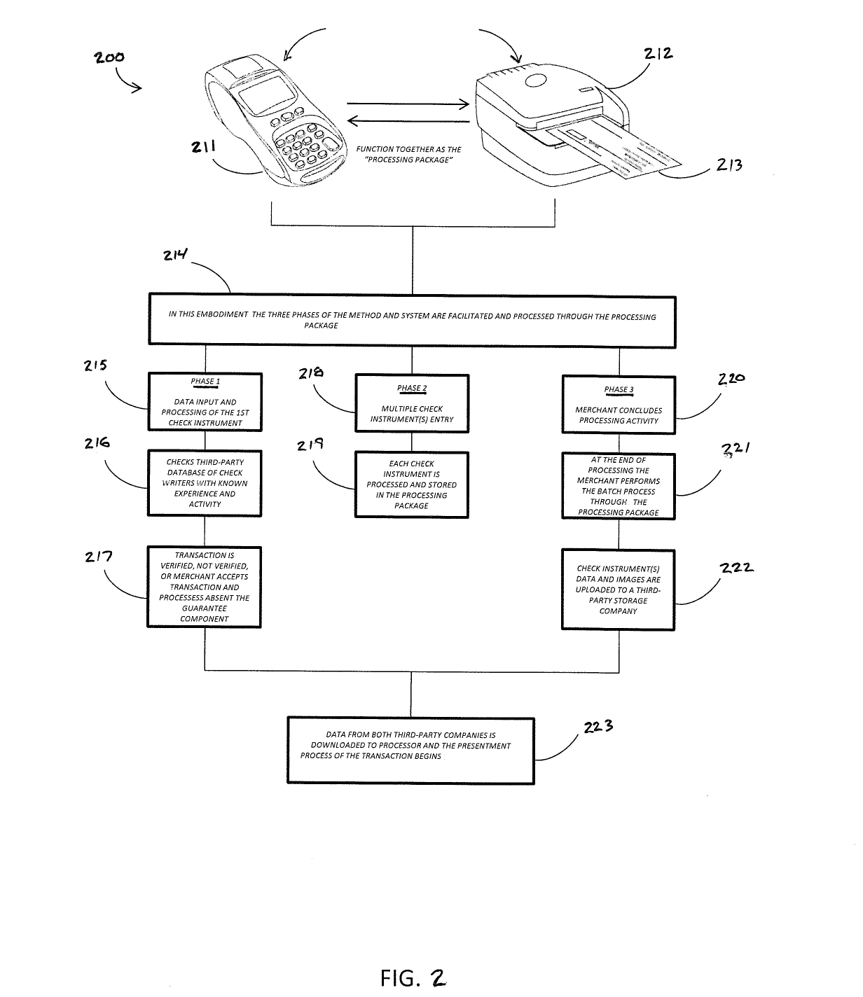

FIG. 2 further illustrates a process 200 in accordance with an embodiment of the invention. Process 200 includes the use of a processing package 210 (i.e., a receiving platform) which comprises a Point Of Sale (POS) terminal 211 and a check instrument reader/imager and storage device 212. The POS terminal 211 contained in the processing package 210 may have a keypad for input of relevant information and data, and the reader/storage device 212 contained in the processing package 210 may include a reader/imager that scans an image of the check instrument(s) and reads the Magnetic Ink Character Recognition (MICR) data from the check instrument(s) 213. POS terminals 211 commonly used in a processing package may include but are not limited to POS terminals manufactured by; VeriFone Systems, Inc. (VeriFone) with Corporate Headquarters in San Jose, Calif., NURIT, formerly a product of Lipman USA with Corporate Headquarters in Syosset, N.Y. whom VeriFone purchased, and Dejavoo Systems with Corporate Headquarters in Syosset, N.Y.

Process 200 exemplifies three Phases 214 that a transaction follows in accordance with an embodiment of the invention when a processing package 210 is utilized. Once steps 100, 102, and 104 of the method described in FIG. 1 are complete, the first step in Phase 1 begins with the inputting of data and processing of the first check instrument at step 215. This involves use of the POS terminal 211 to enter Personal Identification Number (PIN) data unique to the customer (e.g., driver's license number or a state issued identification number or the like), the amount of the negotiated check instrument, and via the use of the reader/storage device 212 the image and

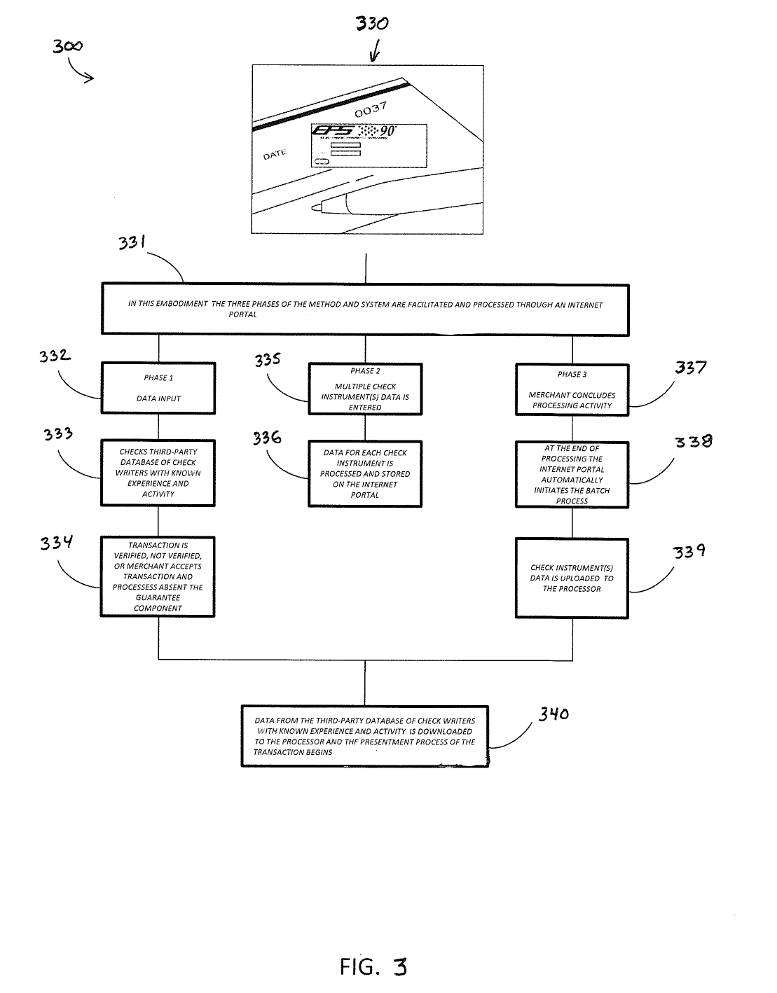

MICR data from the check instrument 213. Through a transmission vehicle (described below in FIG. 3) the compiled data is checked against a third-party database of check writers with known experience and activity at step 216. At step 217, if no negative information (i.e. a history or occurrence of failed checks to other merchants or banks) is contained in the third-party database of check writers with known experience and activity, the transaction is verified. In the alternative, if negative information is discovered the transaction is not verified. If the transaction is not verified and the merchant rejects the transaction the process ends.

If the transaction is verified or in the event the transaction is not verified and the merchant accepts the transaction absent the guarantee component of the program, Phase 2 may start with the entry of additional check instrument(s) that are part of the transaction at step 218 if additional check instrument(s) are a part of the transaction. Each additional check instrument in the transaction is processed through the processing package 210 and for each of these instruments the POS terminal 211 is used to enter the date for deferred presentment and the amount of that presentment at step 219. Once all check instruments to a transaction are processed through the processing package 210 (assuming that the transaction was verified or the merchant accepted the transaction absent the guarantee component of the program), the transaction with the customer is complete.

Phase 3 may commence when the merchant is done processing at step 220.

This step is elective on the part of the merchant and can be at the completion of a transaction, at the end of the day, or even as part of an automatic process assigned to a specific time of day. A batch process is initiated at step 221 with the use of the POS terminal 211. The batch process uploads 222 the check instrument(s) data and images to a third-party storage company. The merchant is now done with their processing obligations for the transaction.

At step 223, a processing entity downloads data from the database of check writers with known experience and activity and from the third-party storage company for processing of the ACH transactions and deferred presentment(s) items to manage through the final stages of the method of FIG. 1 as contained in steps 122, 124, 126, and 130 ending at 110. One possible variation is to step 128 in the event of a failure to clear presentment at the bank which may result in a return to the process at step 130 eventually ending at step 110 or may go directly to step 110 if the item does not qualify for the guarantee component of the program. The aforementioned steps noted in this paragraph are identified here for exemplary purposes only.

FIG. 3 is similar to FIG. 2 and illustrates an alternate processing scheme of a similar method, although there are differences. Process 300 may include the use of an Internet portal 330 (i.e., a receiving platform) which is provided by the processing entity. The Internet portal may evolve in the future with new and improved iterations to keep pace with technology and operating systems and stands as an embodiment of the invention which facilitates a method and system of deferred presentment(s) for the purchase of goods and/or services.

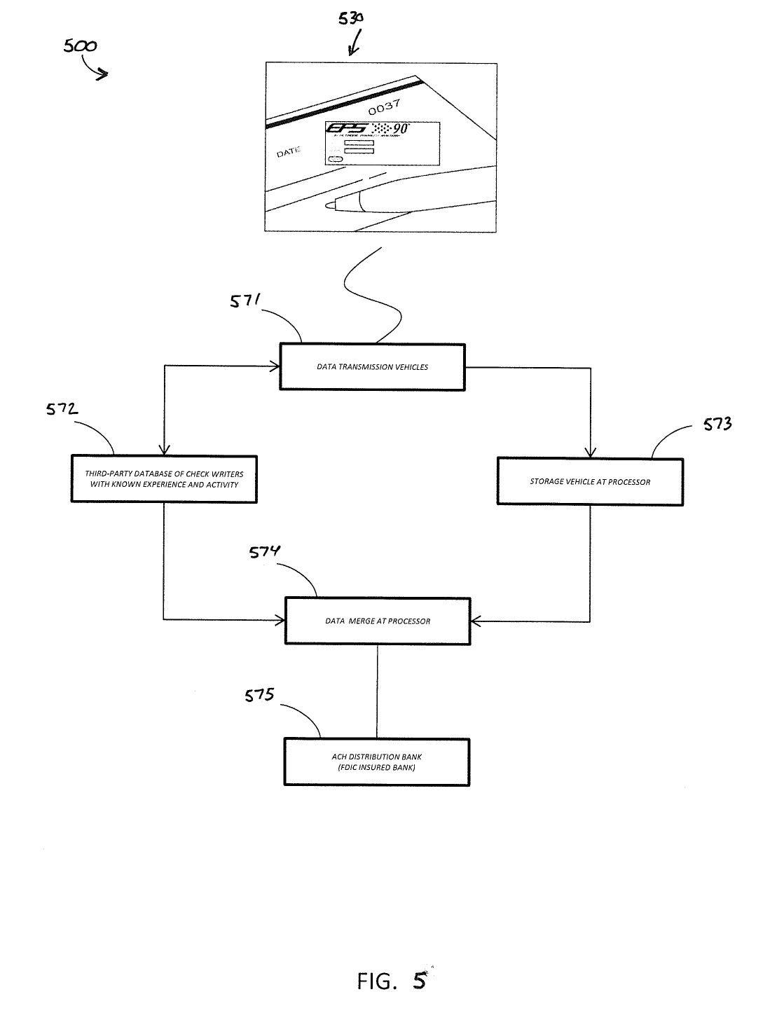

Process 300 also exemplifies the three Phases that a transaction follows in accordance with an embodiment of the invention when an Internet portal 330 is utilized. Once steps 100, 102, and 104 of the method described in FIG. 1 are complete, the first step in Phase 1 begins with the inputting of data at step 332 through the Internet portal 330 including, for example, the name, address, telephone numbers, employer information, income data, and other PIN data unique to the customer (e.g., driver's license number or a state issued identification number), the amount of the negotiated check instrument, and the data contained in the MICR line of the check instrument. Through a data transmission vehicle 571 (FIG. 5) the compiled data may be checked against a third-party database of check writers with known experience and activity at step 333. At step 334, if no negative information (i.e., a history or occurrence of failed checks to other merchants or banks) is contained in the third-party database of check writers with known experience and activity the transaction is verified. In the alternative, if negative information is discovered the transaction is not verified. If the transaction is not verified and the merchant may reject the transaction and the process ends.

If the transaction is verified or in the event the transaction is not verified and the merchant accepts the transaction absent the guarantee component of the program, Phase 2 starts with the entry of additional check instrument(s) data at step 335 that are part of the transaction, if additional instrument(s) are a part of the transaction. Data for each additional check instrument in the transaction is processed through the Internet portal 330 and for each of these instruments the date for deferred presentment and the amount of that presentment is entered at step 336. Once all check instruments to a transaction are processed through the Internet portal 330, assuming that the transaction was verified or the merchant accepted the transaction absent the guarantee component of the program, the transaction with the customer is complete.

Phase 3 commences when the merchant is done processing the transaction at step 337. A batch process is initiated (e.g., automatically) by the Internet portal 330 at step 338. This initiates a process of uploading the check instrument(s) data to the third-party processor 339, i.e., a third-party processor utilizing a processing platform. The merchant is now done with their processing obligations for the transaction.

The processing entity downloads the data from the third-party database of check writers with known experience and activity at step 340 and marries that data with the batched check instrument data at step 339 for processing of the ACH transactions and deferred presentment(s) items to manage through the final stages of the method illustrated in FIG. 1 as contained in steps 122, 124, 126, and 130 ending at 110. One possible variation is to include step 128 in the event of a failure to clear presentment at the bank which may result in a return to the process at step 130 eventually ending at step 110 or may go directly to step 110 if the check instrument does not qualify for the guarantee component of the program.

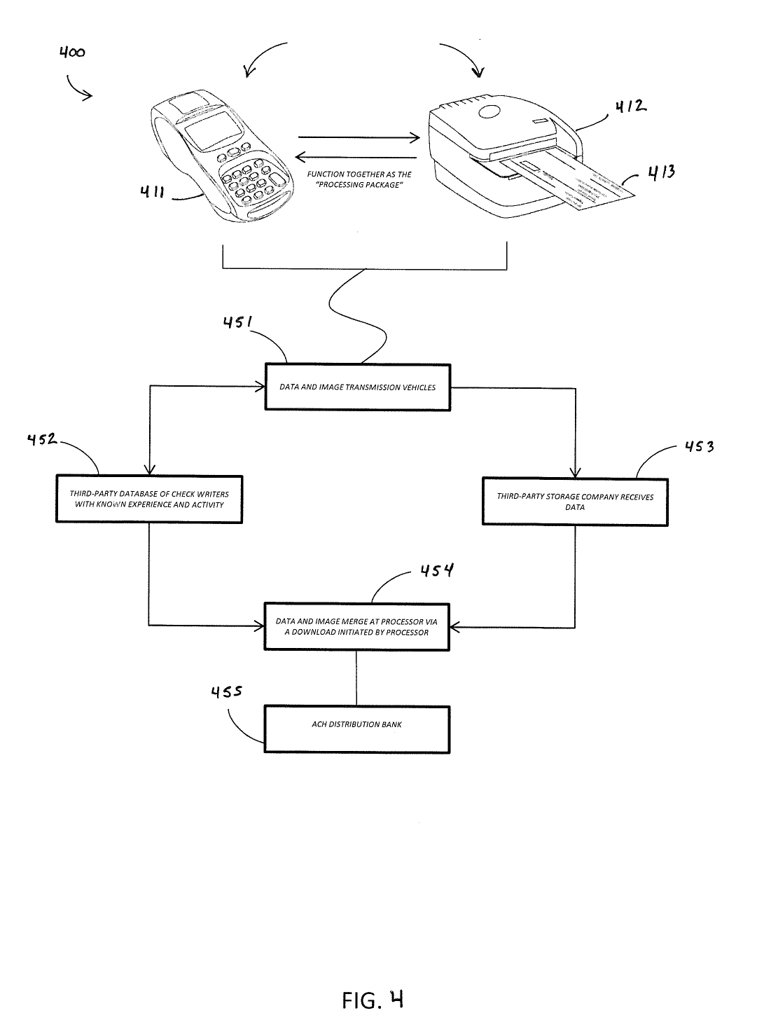

FIG. 4 illustrates another system 400 in accordance with an embodiment of the invention. The steps to carry-out a specific process for the embodiment of FIG. 4 are exemplified in FIG. 2, and FIG. 2 is a demonstrative embodiment of a type of system utilized to complete the method detailed in FIG. 1. FIG. 4 is an embodiment of the invention utilizing a processing package 410 that includes a POS terminal 411 and a check instrument scanner/imager 412. The processing package 410 communicates with at least two different third-party vendors 452 and 453 via a data and image transmission vehicle 451. Currently, typical manifestations of a data and image transmission vehicle 451 include but are not limited to telephone lines, Internet connections via a Local Area Network (LAN), Wireless Wide Area Network (WWAN) broadband Internet connections, and Wi-Fi (a wireless standard for connecting electronic devices to LAN) connections.

The roles of the third-party vendors 452 and 453 have similarities as they both accept MICR data from the check instrument(s) 413 and input from the POS terminal 411, although what they do with the data fundamentally differs. The third-party database of known experience and activity vendor 452 checks the first check instrument (first in the event of multiple check instruments and the subject check instrument in the event of a single item transaction) against a dynamic database querying for a match to existing activity, good or bad. Based on the result of the query, the third-party database of known experience and activity vendor 452 responds back to the merchant via the data and image transmission vehicle 451. If the result of the query is not verified the merchant has the option of accepting or rejecting the transaction. In the event of a rejection the transaction ends at this juncture. For the sake of this discussion it will be assumed that the transaction is verified or the merchant accepted the transaction without the guarantee component of the service. Once the merchant receives the verification of the first check instrument the merchant may start the input of the additional check instrument(s). All subsequent transmission(s) of data and image(s) for additional check instruments and the image of the first check instrument may be stored in the processing package 410 until a batch process is initiated sending the data and image(s) to a third-party storage database 453 to be stored until accessed by the processing entity.

At step 454, the processing entity downloads the data and image(s) from the respective third-party vendors 452 and 453 and merges the data to create one transaction that may have multiple deferred presentments (one deferred presentment in the event of a single check instrument transaction and multiple check instruments in the event of a multi-part deferred presentment transaction). Based on the deferred presentment date of the ACH transaction, the data is sent to an ACH distribution bank for execution of the presentment at step 455.

FIG. 5 illustrates another system 500 in accordance with an embodiment of the invention. The steps to carry out a process for the embodiment discussed in FIG. 5 is exemplified in FIG. 3, and FIG. 3 is a demonstrative embodiment of a type of system to carry out the method detailed in FIG. 1. FIG. 5 illustrates an embodiment of the invention utilizing an Internet portal 530. The Internet portal 530 communicates with a third-party database of known experience and activity 572 via a data transmission vehicle 571. Currently, typical manifestations of a data transmission vehicle 571 include but are not limited to Internet connections via a Local Area Network (LAN), Wireless Wide Area Network (WWAN) broadband Internet connections, and Wi-Fi (a wireless standard for connecting electronic devices to LAN) connections.

The role of the third-party database of known experience and activity 572 is to accept MICR data in the form of keyed entries via the Internet portal 530 from the check instrument(s). The vendor operating the third-party database of known experience and activity 572 checks the first check instrument (first in the event of multiple check instruments and the subject check instrument in the event of a single check instrument transaction) against a dynamic database querying for a match to existing activity, good or bad. Based on the result of the query, vendor operating the third-party database of known experience and activity 572 responds back to the merchant via the data transmission vehicle 571. If the result of the query is not verified the merchant has the option of accepting or rejecting the transaction. In the event of a rejection the transaction ends at this juncture. For the sake of this discussion it will be assumed that the transaction is verified or the merchant accepted the transaction without the guarantee component of the service. Once the merchant receives the verification of the first check instrument data the merchant can start the input of the additional check instrument(s) data. All subsequent transmission(s) of data for additional check instruments are stored on the Internet portal 530 in a storage vehicle 573 at the processing entity 573 until accessed by the processing entity.

The processing entity downloads the data from the third-party database of known experience and activity 572 and merges that data with the data on the Internet portal 530 relating to the check instruments at step 574 to create one transaction that may have multiple deferred presentments (one deferred presentment in the event of a single check instrument transaction and multiple check instruments in the event of a multi-part deferred presentment transaction). Based on the deferred presentment date of the ACH transaction, the data is sent to an ACH distribution bank for execution of the presentment at step 575.

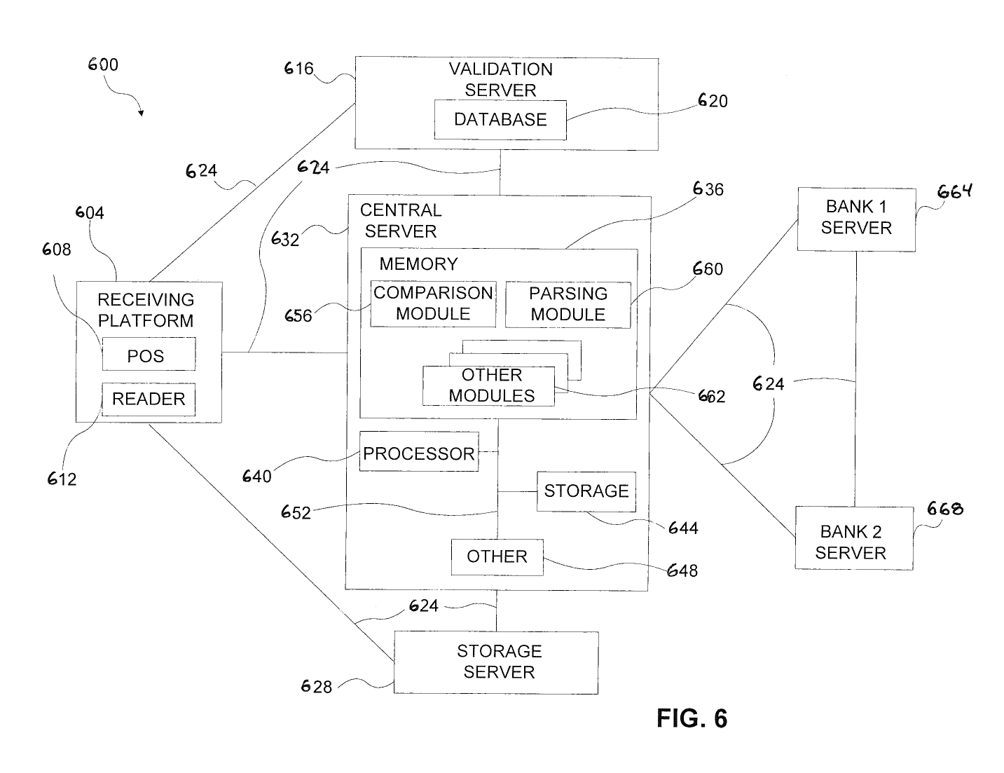

FIG. 6 illustrates a further embodiment of a system 600 for use in facilitating a deferred presentment transaction between parties. Before discussing the system 600 in more detail, it may be useful to provide one example of the general context in which the system 600 may be utilized. In one scenario, at least one merchant or other party may agree in any appropriate manner (e.g., in person, electronically, etc.) to sell one or more goods and/or services to at least one customer or other parties in exchange for one or more deferred presentment payments (i.e., the merchant and customer may engage in a deferred presentment transaction). For instance, the merchant and customer may agree on a price that includes the exact cost for the goods and/or services along with any appropriate taxes (e.g., sales or otherwise as dictated by the local laws and tax authorities) or fees (e.g., service fees, program participation fees). The parties may also agree on the number and amount of deferred presentments, the date of each deferred presentment, and the like.

Thereafter, the customer may present one or more check instruments (e.g., a series of check instruments) and the merchant may prepare any appropriate consumer agreement including general information such as current date, parties to the agreement (i.e., the names of the merchant and customer), the particular goods and/or services, the total amount of the transaction (e.g., in dollars), and the like. The consumer agreement may also include information corresponding to each of the one or more deferred presentments such as check number, base amount of currency of check instrument, fees, date to pay (e.g., date of presentment), and the like. For instance, it is envisioned that the date of presentment may be any appropriate period of time out from the date of the transaction (e.g., 30 days, 60 days, 90 days, etc.). Additionally, the agreement may also include customer personal information such as name, employer name, home address, phone numbers, any appropriate personal ID or PIN (e.g., driver's license number), blanks for signatures of the customer and merchant representative, etc.

In any event, the customer may desire to present a check instrument for deferred presentment to the merchant in exchange for the good(s) and/or service(s). As discussed above, previous manners of engaging in deferred presentment transactions often resulted in high levels of financial risk for merchants that accepted check instruments as payment for goods and/or services. The system 600 is designed to alleviate or at least partially limit the inefficiencies and risks associated with these previous manners of engagement.

As shown in FIG. 6, the system 600 may include at least one receiving platform 604 that is broadly operable to receive and/or store information and/or data associated with one or more deferred presentments, such, for example, at least some of the information included in a consumer agreement. For instance, each of a number of merchants may have access to one or more receiving platforms 604. In one arrangement, the receiving platform 604 may include a Point Of Sale (POS) terminal 608 and a check instrument reader/imager 612. For instance, the POS terminal 608 may include any appropriate input device(s) (e.g., keypad, touch-screen, microphone, and/or the like) for the input of relevant information and data such as a customer PIN (e.g., customer's driver's license number), the amount of currency of each check instrument, the date of presentment of each check instrument, and the like. As is noted above, examples of POS terminals 608 may include, but are not limited to, those manufactured by: VeriFone Systems, Inc. (VeriFone) with Corporate Headquarters in San Jose, Calif.; NURIT, formerly a product of Lipman USA with Corporate Headquarters in Syosset, N.Y.; and Dejavoo Systems with Corporate Headquarters in Syosset, N.Y.

The reader 612 of the receiving platform 600 may function to scan an image of the check instrument(s) and read the Magnetic Ink Character Recognition (MICR) data from the bottom of the check instrument(s). For instance, the MICR data may include information related to a financial institution (e.g., bank) of the account from which funds will or should be drawn to satisfy the amount of currency for which the check instrument was written (e.g., routing number of the financial institution, account number, etc.). In one arrangement, the POS terminal 608 and reader 612 may be in appropriate communication with each other either directly or indirectly (e.g., each of the POS terminal 608 and reader 612 may be electrically interconnected to any appropriate computing device such as a laptop, smartphone, tablet, etc.) in any appropriate manner (e.g., wired, wirelessly). Furthermore, and while not shown, each of the POS terminal 668 and reader 612 may include any appropriate components for carrying out programs and logic such as one or more memory devices (e.g., volatile, non-volatile) for storing data (e.g., the received check data) and instructions (e.g., instructions operable to manipulate the data to carry out the functionalities disclosed herein), one or more processors (for executing instructions), and the like.

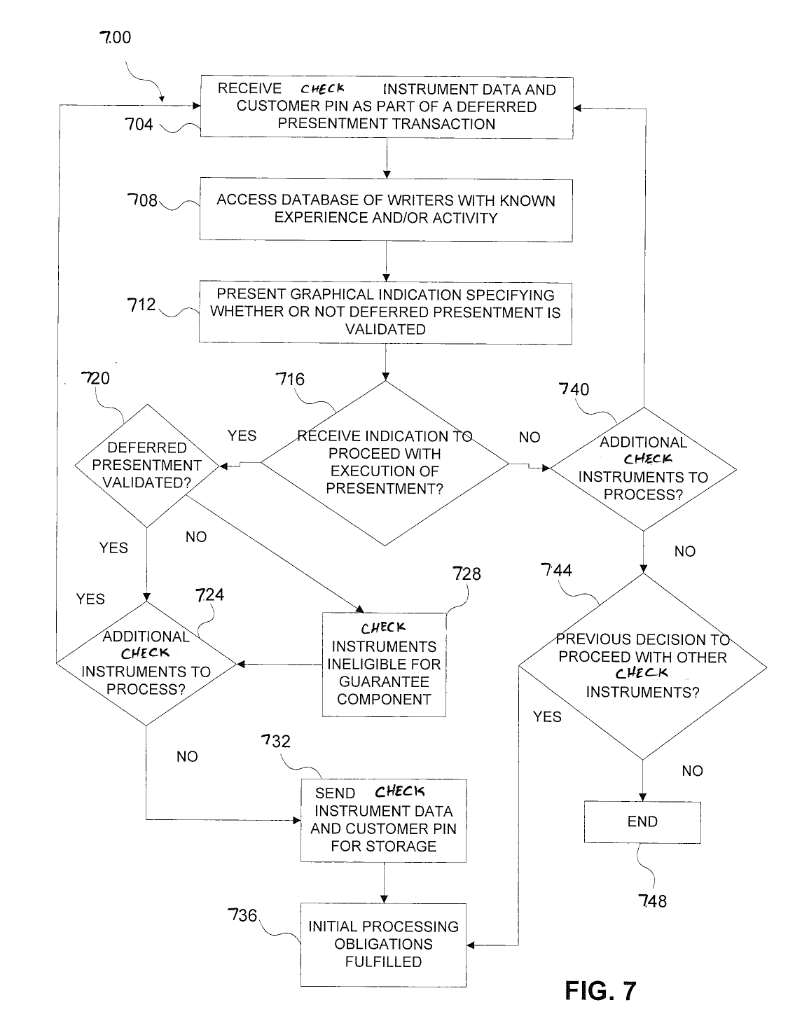

In conjunction with a discussion of additional components of the system 600, reference will also now be made to FIG. 7 which illustrates a method 700 for use in one or more deferred presentment transactions between parties. The method may include receiving 704 check instrument data and at least one customer pin as part of a deferred presentment transaction. For instance, the receiving platform 604 (via the POS terminal 608 and check reader 612) may receive data related to a first (or a single) check instrument of a deferred presentment transaction between a merchant and a customer as discussed previously (e.g., data such as customer PIN, check amount, date of presentment, MICR data, etc.). The received data may be stored in any appropriate manner either at this point and/or as part of a later step of the method 700. For instance, the data may be stored in any appropriate database (e.g., according to transaction number, customer PIN, etc.) resident on the POS terminal 608.

In any event, the method 700 may also include accessing 708 a database of check writers with known check writing experience and/or activity for use in generally characterizing a likelihood of the particular account associated with the check (e.g., as identified by the MICR data) being able to satisfy the amount indicated on the check instrument on the date of presentment.

In one embodiment, and returning to FIG. 6, the system 600 may include a validation server 616 (e.g., which may be managed by any appropriate third-party vendor) having at least one database 620 that stores information regarding previous check writing experience and activity of a number of parties. For instance, the accessing step 708 may entail the receiving platform 604 transmitting the received check instrument data (e.g., MICR data, amount, date of presentment, and/or the like) corresponding to at least one check instrument and customer PIN to the validation server 616 over any appropriate transmission vehicle(s) or network(s) 624 (e.g., telephone line, Local Area Network (LAN), Wireless Wide Area Network (WWAN), broadband Internet connections, Wi-Fi (a wireless standard for connecting electronic devices to LAN) connections, satellites, etc.). The validation server 616 may then check the received check instrument data (e.g., corresponding to a single item transaction or one in a series of transactions) and/or customer PIN against the database 620 (e.g., a dynamic database) as part of a query for existing check writing activity (e.g., negative, positive, etc.) corresponding to the particular check writer and/or account number.

For instance, logic resident on or at least associated with the validation server 616 may function to identify matches between one or more of the various types of data (e.g., customer PIN, account number, etc.) received from the receiving platform 604 and activity entries in the database 620. In one variation, logic associated with the validation server 616 may analyze the various experience and historical data for each check writer (as associated by their PIN, account number, etc.) and automatically determine a status (e.g., validated or verified, invalidated or not verified, etc.) of the check instrument or deferred presentment of a deferred presentment transaction in question. For example, a lack of negative check writing information (e.g., a history or occurrence of failed checks to other merchants or banks) may cause the logic to generate a “validated” or “verified” status while at least some negative check writing information may cause the logic to generate an “invalidated” or “not verified” status.

Furthermore, the validation server 616 may function to maintain substantially current or up to date activity information in the database 620 so that a substantially real-time status may be generated. For instance, the validation server 616 may store (e.g., in the database 620) details regarding the current check instrument or transaction.

In any case, the validation server 616 responds back to the receiving platform 604 via the network(s) 624 with any appropriate information. In one arrangement, the validation server 616 may pass a status (e.g., validated, invalidated) back to the receiving platform 616 for a particular check instrument. In another arrangement, the validation server 616 may additionally or alternatively pass back relevant activity data to the receiving platform 604 and allow any appropriate logic on the receiving platform (e.g., resident in memory of the POS terminal 608) to analyze the data and generate an appropriate status. Other arrangements are also envisioned and encompassed within the scope of the present disclosure.

Returning to FIG. 7 and once a status of the individual check instrument has been determined or otherwise ascertained, the method 700 may include presenting 712 a graphical indication on a user interface that specifies whether or not the transaction has been validated. For example, a graphical indication of the status of the current check instrument may be presented on a display of the POS terminal 708, or announced through a speaker of the POS terminal 708, and/or the like.

Once the status has been conveyed to the merchant (e.g., via the POS terminal 608 or check reader 612), the merchant may choose whether or not to proceed with the current deferred presentment transaction. While the merchant may in some arrangements choose to proceed regardless of whether the transaction has been validated or invalidated, choosing to proceed when the transaction has been invalidated may have repercussions different than those that arise when the merchant chooses to proceed when the transaction has been validated.

In one arrangement, the system 600 may include what will be referred to as a “guarantee component” or “guarantee aspect” that is available to a merchant in conjunction with a validated deferred presentment or transaction but not with an invalidated deferred presentment or transaction. The guarantee component may allow for funds to be distributed to the merchant (e.g., to a financial institution or bank of the merchant) in the event that a check associated with the validated deferred presentment transaction eventually fails to clear a financial institution or bank of the check writer (e.g., due to lack of sufficient funds).

In this regard, and with reference to FIG. 7, an affirmative answer to a query 716 as to whether an indication has been received (e.g., from the merchant) to proceed with execution of the transaction and a negative answer to a query 720 as to whether the transaction has been validated results in the check instrument being ineligible 728 for the guarantee component. Stated otherwise, a transaction does not qualify for the guarantee component when a merchant chooses to proceed with an invalidated transaction and does qualify for the guarantee component when the merchant chooses to proceed with a validated transaction. In any case, the various check instrument data and the customer PIN may be appropriately stored on the receiving platform (e.g., in the POS terminal 708) in any appropriate database or other manner as discussed previously. In one arrangement, the check instrument data and/or customer PIN may be appropriately enriched with the status of the particular check instrument (e.g., in the form of metadata appended to the check instrument data) for use by subsequent components of the system 600. In any event, the previously described manners and processes of inputting check instrument data and customer PIN, accessing the validation server 616 to determine whether the transaction or individual deferred presentment is validated or not, and choosing whether or not to proceed with transaction execution (either with or without a guarantee component) may be referred to as a first phase or “Phase I” of the deferred presentment transaction from the perspective of the receiving platform 604 (e.g., see FIG. 2).

Regardless of whether the guarantee component applies to the particular check instrument in question, the method 700 may eventually query 724 whether there are additional checks instruments to process as part of the current transaction. In response to an affirmative answer, the method 700 may return to receive 704 check instrument data for another check instrument (e.g., amount, date of presentment, which may be different than that for the previous check instrument) via the receiving platform 604 of FIG. 6, accessing 708 the database 620 of writers with known experience and/or activity, etc. While not necessarily required (e.g., in the event of a deferred presentment transaction including only a single check instrument), this process may be referred to as a second phase or a “Phase II” of the deferred presentment transaction from the perspective of the receiving platform 604.

Once it has been determined at step 724 that there are no additional check instruments to process, the method 700 may proceed to retrieve all of the check instrument data related to the one or more check instruments and customer PIN and send 732 the check instrument data and customer PIN for storage at any appropriate location and in any appropriate manner (the sending step 732 will be discussed in more detail below). At this point, the initial processing obligations have generally been fulfilled.

With continued reference to FIG. 7, if there was not an indication to proceed with execution of the particular check instruments at 716, the method 700 may query 740 whether there are additional check instruments to process.

If it was determined at 740 that there are no additional check instruments to process, then the method 700 may query 744 whether there was a previous decision to proceed with other check instruments. In response to a negative answer to the query at 744, the method may end 748; otherwise, the initial processing obligations have been fulfilled 736 whereby execution will continue for those check instruments for which the method 700 received an indication to proceed.

As discussed above, the check instrument data for each of the one or more check instruments of the deferred presentment transaction and the customer PIN may be sent 732 for storage in any appropriate manner. This process may be referred to as a third phase or a “Phase III” of the deferred presentment transaction from the perspective of the receiving platform 604. In one arrangement, the merchant may initiate a batch process of sending the check instrument data for a plurality of check instruments over network(s) 624 for receipt at a central server 632 (e.g., either indirectly via sending the information to a storage server 628 which then passes the information to the central server 632 or directly to the central server 632 as will be discussed in a later embodiment). The merchant may initiate uploading of data to the storage server 628 (e.g., which may be managed by any appropriate third-party vendor either different from or the same as that of the validation server 616) by way of appropriately interacting with the receiving platform 604, for example at the end of each business day (e.g., whereby data from all deferred presentment transactions of the day would be sent to the storage server 628 as part of a batch process), at the end of each transaction (e.g., whereby just the data from the particular transaction would be uploaded to the storage server 628), according to a predetermined schedule (e.g., hourly), and/or the like. For instance, the batch process may be initiated with the use of a keypad on the POS terminal 608 by depressing buttons of the keypad. It is noted that the specific buttons and/or number of buttons to push may change depending on the configuration of the POS terminal 608.

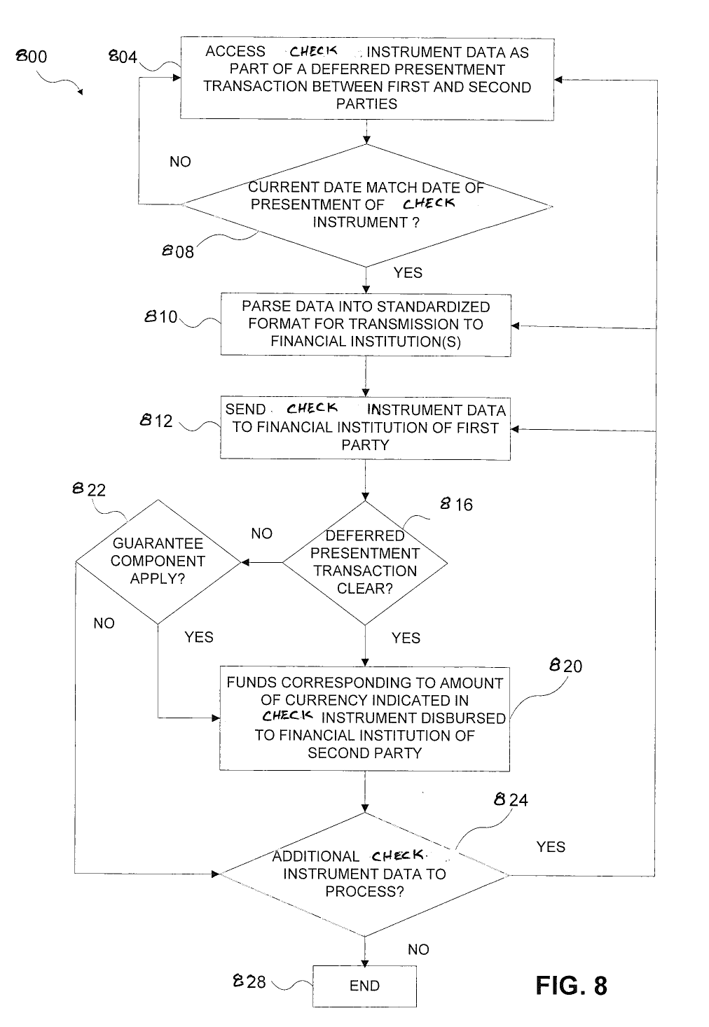

The merchant's processing obligations are generally fulfilled 736 for one or more deferred presentment transactions once the check instrument data has been uploaded to the storage server 628. At this point, continued processing of each of the one or more deferred presentment transactions is generally handled by the central server 632 as will be described in more detail in relation to FIG. 8 below. While the central server 632 will be shown and described as a single device (e.g., server, laptop, desktop, mobile device, and/or other computing device), one or more functionalities or processes of the central server 632 may be allocated among a number of machines, devices and/or processes which may or may not be embodied in a single housing.

Similar to many of the other components of the system 600 (e.g., the validation server 616, storage server 628, etc.), the central server 632 may include memory 636 (e.g., one or more RAM or other volatile memory modules), a processor 640 (e.g., one or more CPUs) for executing computer readable instructions from the memory 636, storage 644 (e.g., one or more magnetic disks or other non-volatile memory modules), and/or a number of other components 648 (e.g., input devices such as a keyboard and mouse, output devices such as a display and speakers, and the like), all of which may be appropriately interconnected by a system bus 652. While not shown, the central server 632 may include any appropriate number and arrangement of interfaces (e.g., storage interface, video interface, network interface) for facilitating interconnection (e.g., transmitting and/or receiving data and/or messages) between the system bus 652 and the various components of the server 632 as well as with other devices (e.g., receiving platform 604, validation server 616, storage server 628) via network(s) 624.

Turning now to FIG. 8, a method 800 is shown that includes accessing 804 check instrument data of one or more deferred presentment transactions between first and second parties (e.g., between one or more merchants and one or more customers). In one arrangement, the central server 632 (FIG. 6) may appropriately download check instrument and customer PIN data from the storage server 628 according to any appropriate schedule (e.g., hourly, daily, etc.) and store the data in one or more databases in storage 644 for subsequent use by processor 640 as will be described. In some arrangements, the central server 632 may also download corresponding check writer activity information from the database 620 of the validation server 616 and marry the check writer activity information to corresponding check instrument data in the database storage 644 in any appropriate manner. As an example, the central server 632 may utilize customer PINs as an identifier to identify and match check instrument data and check writer activity information corresponding to the same customer PIN. For instance, in association with step 708 of FIG. 7, the validation server 616 may store the determined status with the particular PIN from the retrieved check instrument data to allow the central server 632 to retrieve the corresponding status (e.g., validated, invalidated) from the validation server 616.

In any case, once the central server 632 has at least partially populated storage 644 with check instrument data, customer PINs, and corresponding check writer activity and/or status information (e.g., as part of one or more transactions between one or more merchants and one or more customers), the method 800 of FIG. 8 may proceed to systematically query 808 whether the date of presentment of a particular check instrument matches a current date. For instance, and with reference again to FIG. 6, the memory 636 of the central server 632 may include a number of modules (e.g., sets of computer-readable instructions) which may be loaded into the processor 640 for execution, one of which may be a may be a comparison module 656. The comparison module 656 may be operable to systematically retrieve at least the date of presentment of each of a number of sets of check instrument data corresponding to a number of check instruments from storage 644 and compare each date of presentment to the current date. A negative answer to the query at 808 for one or more of the check instruments may cause the method 800 to re-perform the query 808 in relation to the respective one or more check instruments at a later time (e.g., by way of accessing the data from storage 644 during the next scheduled query of check instrument data).

Otherwise, the central server 632 may proceed to parse 810 each of the sets of married data (i.e., sets of check instrument data and check writer activity or status information for each particular check instrument or deferred presentment) for those check instruments associated with an affirmative answer to the query at 808 into a standardized format that allows the data to be transmitted to one or more appropriate banks or other financial institutions for presentment. For instance, the central server 632 may include a parsing module 660 that is operable to retrieve the above-mentioned married data and parse or otherwise format the data into a form suitable for transmission to one or more banks. In one arrangement, each set of married data may be converted into a format prescribed by the governing body of the ACH Network (NACHA) for transmission to a bank via an electronic funds transfer (EFT) such as an ACH transaction over network(s) 624. However, the present disclosure envisions conversion into other standardized formats either currently existing or those that may arise in the future. In those arrangements where the married data is already in format that allows for transmission via an ACH or other particular transaction, the parsing step 810 need not be performed.

The method 800 may also include transmitting or sending 812 the married, standardized check instrument data and customer PIN to a financial institution (e.g., an ACH distribution bank of a first party such as the customer or check writer) for execution of the check instrument. That is, each check instrument may be presented to the financial institution associated with the check instrument by way of the married and standardized check instrument data for obtaining funds totaling the amount indicated in the check instrument data for the particular check instrument under consideration. For instance, and turning again to FIG. 6, the central server 632 may serve to pass the married, standardized check instrument data and customer PIN to a first bank server 664 that corresponds to a financial institution of the particular check writer (e.g., the customer). The method 800 may then make a determination at 816 as to whether the particular check instrument cleared the first bank. For instance, the central server 632 may receive any appropriate message from the first bank server 664 that the check instrument cleared the first bank.

Upon the deferred presentment clearing, funds corresponding to the particular amount of currency specified in the check instrument data may be disbursed 820 to the merchant (e.g., less any appropriate fees associated with and contractually agreed to for the transaction). In one arrangement, funds may be electronically disbursed from the first bank server 664 directly to a bank (e.g., second bank server 668) at which the merchant has one or more accounts via an ACH transaction over network(s) 624. In conjunction with the crediting of the merchant's bank account with the corresponding funds, the first and/or second bank server 664, 668 may pass any appropriate message over network(s) to central server 632 reporting the same. For instance, the central server may store this information in storage 644 (e.g., along with the customer PIN and/or other check instrument data) and/or report the information to the validation server 616 to update the check writer experience and activity database 620 (e.g., to reflect that the particular check writer was associated with a positive check writing experience, namely, that a check cleared a bank). Additionally or alternatively, the first and/or second bank server 664, 668 may pass such information directly to the validation server 616 via network(s) 624. While only two banks have been shown, it should be understood that the central server 632 may interact with and otherwise communicate with many more banks and other financial institutions associated with numerous different merchants, customers, and the like.

In the event that the deferred presentment was determined at 816 to not have cleared the check writer/customer's bank (e.g., via a rejection message received at central server 632 from the first bank server 664), the method 800 may proceed to determine 832 whether the guarantee component applies to the particular deferred presentment under consideration. As discussed previously, the guarantee component may apply when the merchant or other party opted to proceed with a validated or verified deferred presentment. For instance, step 832 may entail analyzing the married and standardized check instrument data for the particular deferred presentment and/or customer PIN to determine if it is associated with a validated or verified status. An affirmative answer to the determination at 832 may return the method 800 to 820 whereby funds may be disbursed to the second bank (e.g., the merchant's bank). In this situation, the funds would not come from the customer's account at the first bank, but from another source (e.g., an account associated with the vendor or other party managing the system 600 or the central server 632).

The method 800 may also query 824 whether there is additional check instrument data that needs processing. For instance, the previously processed check instrument may be one of a series of check instruments making up a deferred presentment transaction. If so, the method 800 may return to step 812 whereby the data may be sent to a bank or financial institution of the customer (which financial institution may be the same as or different than that of the previously processed check instrument). Alternatively, the method 800 may return to step 810 (e.g., if the additional check instrument data has not yet been converted into a standardized format) or step 804 (e.g., if it is not yet known whether the date of presentment of the additional check instrument data matches the current date). In any event, the method 800 may eventually end at 828 when no further check instrument data remains waiting for processing (e.g., at the end of a day when all check instrument data in storage 644 with dates of presentment matching the current day has been processed). The central server 632 may also include one or more additional modules 662 which may function to perform one or more other tasks associated with the execution of a deferred presentment transaction.

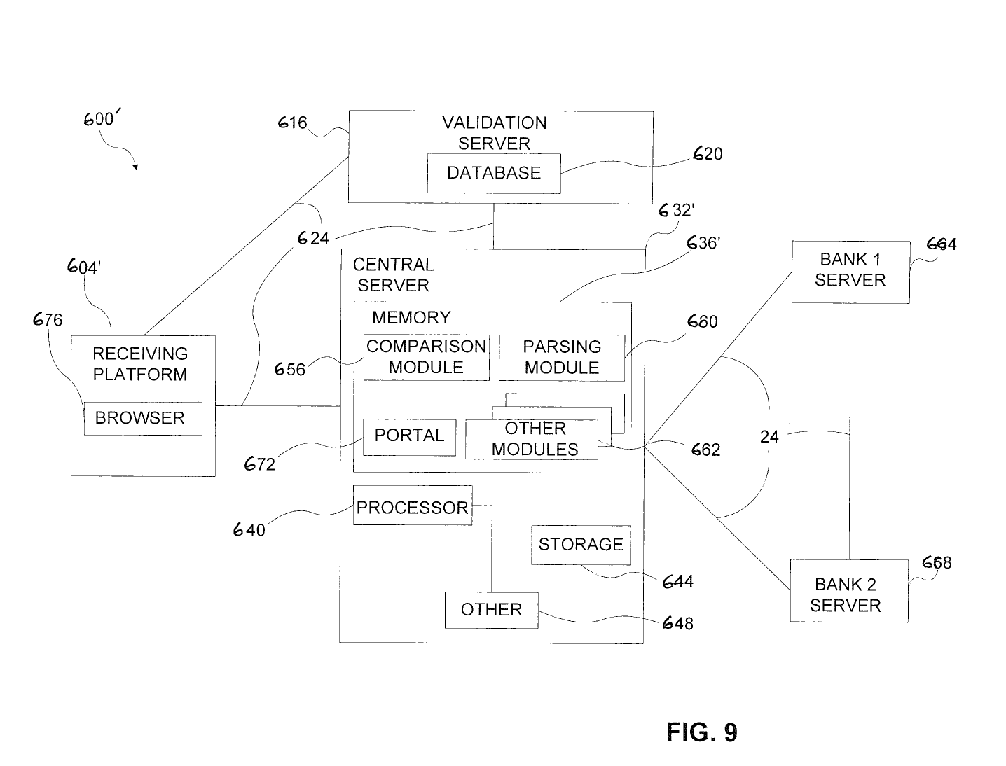

With reference now to FIG. 9, another embodiment of the system 600 is illustrated, and those components or features that have changed between FIGS. 6 and 9 are illustrated with a single prime designation in FIG. 9. In the system 600′ of FIG. 9, the central server 632′ may include an Internet or web portal 672 (e.g., web site) in memory 636′ which may be accessible to a merchant or other party by way of an Internet or web browser 676 running on receiving platform 604′ (e.g., laptop, desktop, smartphone, etc. having a display, keyboard or keypad, etc.). For example, a merchant may, after completing a consumer agreement, utilize the browser 676 to access the web portal 672 over network(s) 624 whereby the merchant may be able to input the same or similar information into the portal 672 via the browser 676 as is collected and received by the POS terminal 608 and check reader 612 of FIG. 6. In one arrangement, and upon access of the portal 672, the merchant may be required to enter any appropriate credentials (e.g., user name and password) that serve to identify the merchant. For instance, the merchant may have previously set up an account on the portal 672 with identifying information, bank account information (e.g., routing and account numbers), etc.

The merchant may eventually be directed to a screen whereby check instrument data (e.g., check amount, date of presentment, MICR data) and customer identifying information (e.g., customer PIN such as a driver's license number) may be entered. In one arrangement, the POS terminal 608 and/or check reader 612 of FIG. 6 may be used in conjunction with the browser 676 and portal 672 of FIG. 9 (e.g., the merchant may use the check reader 612 to input the MICR data and the browser 676 to enter a customer PIN, check amount, etc.). The portal 672 may serve to pass the check instrument data for storage in the one or more databases of storage 644 as discussed above in relation to FIG. 6. In this regard, it may be noted how instead of the receiving platform 604′ uploading the check instrument data to the storage server 628, the receiving platform 604′ may upload the check instrument data (e.g., via the browser 676) directly or substantially directly to the central server 632′. Also, the previous discussion of FIGS. 7-8 in relation to the system of FIG. 6 is also applicable to the system 600′ of FIG. 9. Furthermore, the portal 672 may evolve in the future with new and subsequent iterations to keep pace with technology and/or various operating systems.

It will be readily appreciated that many deviations may be made from the specific embodiments disclosed in the specification without departing from the spirit and scope of the invention. Also, it should be understood that the functionalities performed by many of the processes and modules discussed herein may be performed by other modules, devices, processes, and the like. The illustrations and discussion herein has only been provided to assist the reader in understanding the various aspects of the present disclosure. Furthermore, one or more various combinations of the above discussed arrangements and embodiments are also envisioned

Embodiments disclosed herein can be implemented as one or more computer program products, i.e., one or more modules of computer program instructions encoded on a computer-readable medium for execution by, or to control the operation of, data processing apparatus. For example, the various components (e.g., modules) of the central server may be provided in such computer-readable medium and executed by a processor or the like. The computer-readable medium can be a machine-readable storage device, a machine-readable storage substrate, a memory device, a composition of matter affecting a machine-readable propagated signal, or a combination of one or more of them. The system 600, 600′ may encompass one or more apparatuses, devices, and machines for processing data, including by way of example a programmable processor, a computer, or multiple processors or computers. In addition to hardware, the system 600, 600′ may include code that creates an execution environment for the computer program in question, e.g., code that constitutes processor firmware, a protocol stack, a database management system, an operating system, or a combination of one or more of them.

A computer program (also known as a program, software, software application, script, or code) used to provide any of the functionalities described herein (e.g., comparing current dates to dates of execution, parsing data into standard formats for execution of transaction, and the like) can be written in any form of programming language (e.g., Fortran, C++, etc.), including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit). Processors suitable for the execution of a computer program may include, by way of example, both general and special purpose microprocessors, and any one or more processors of any kind of digital computer. Generally, a processor will receive instructions and data from a read-only memory or a random access memory or both. Generally, the elements of a computer are one or more processors (for performing instructions and one or more memory devices for storing instructions and data. The techniques described herein may be implemented by a computer system configured to provide the functionality described.

In different embodiments, the system 600, 600′ may include one or more of various types of devices, including, but not limited to a personal computer system, desktop computer, laptop, notebook, or netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, or, in general, any type of computing or electronic device.

Typically, a computer will also include, or be operatively coupled to receive data from or transfer data to, or both, one or more mass storage devices for storing data, e.g., magnetic, magneto-optical disks, or optical disks (e.g., storage 644 of central server 632). However, a computer need not have such devices. Moreover, a computer can be embedded in another device, e.g., a mobile telephone, a personal digital assistant (PDA), a mobile audio player, a Global Positioning System (GPS) receiver, a digital camera, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry. To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described embodiments including the preferred embodiment and the best mode of the invention known to the inventor at the time of filing are given by illustrative examples only.

What is claimed is:

1. A method for facilitating a deferred presentment transaction between parties, the method comprising:
first inputting, at a receiving platform, first check instrument data relating to a first check instrument presented by a first party to a second party as part of a deferred presentment transaction, the data comprising at least first party identification data and a first date of presentment;
accessing, via at least one communications network, a database of records for parties that have previously presented check instruments to other parties;
presenting, on a user interface associated with the receiving platform and based on the accessing step, an indication specifying whether or not the deferred presentment transaction is validated;
second inputting, at the receiving platform, second check instrument data relating to a second check instrument presented by the first party to the second party as part of the deferred presentment transaction, the second check instrument data comprising at least a second date of presentment;
storing the first check instrument data and the second check instrument data on a storage medium associated with the receiving platform; and
transmitting, over a data transmission vehicle, at least the first check instrument data and the second check instrument data to a third-party storage entity during a batch upload process.

2. The method of claim 1, wherein the deferred presentment transaction is validated responsive to the database being free of a record indicating that the first party previously presented at least one prior check instrument to a party that failed to clear a financial institution associated with the first party.

3. The method of claim 1, wherein the deferred presentment transaction is invalidated responsive to the database including at least one record indicating that the first party previously presented at least one prior check instrument to a party that failed to clear a financial institution associated the first party.

4. The method of claim 1, wherein the presenting step comprises:
presenting, on the user interface, a graphical indication specifying that the deferred presentment transaction is invalidated; and
providing the second party with an option to proceed with the deferred presentment transaction.

5. The method of claim 1, wherein the transmitting step occurs at a predetermined time.

6. The method of claim 1, wherein the batch upload process comprises transmitting of check instrument data relating to a plurality of check instruments, including at least a third check instrument, and including at least a check instrument amount and a date of presentment for each check instrument.

7. The method of claim 6, wherein the method further comprises the step of receiving, at the receiving platform, an indication that funds corresponding to at least the first check instrument amount have been received at a financial institution associated with the second party.

8. The method of claim 1, wherein the receiving platform comprises at least one of a point of sale (POS) device and a check instrument image scanner

9. The method of claim 1, wherein the receiving platform comprises a web portal in operative communication with the Internet.

10. The method of claim 1, wherein the data related to the check instruments further comprises information regarding a financial institution associated with the first party.

11. The method of claim 10, wherein the information regarding a financial institution associated with the first party comprises a routing number of the financial institution of the first party and a financial account number of the first party held at the financial institution of the first party.

12. The method of claim 11, wherein the information regarding a financial institution of the first party comprises Magnetic Ink Character Recognition (MICR) data.

13. A method for use in facilitating a deferred presentment transaction between parties, the method comprising:
accessing, at a processing platform, data corresponding to at least one check instrument presented by a first party to a second party as part of a deferred presentment transaction, wherein the data comprises at least an amount to be paid from the first party to the second party and a date of presentment;
determining whether a current date matches the date of presentment of the at least one check instrument;
responsive to the current date failing to match the date of presentment of the at least one check instrument, re-performing the determining step;
responsive to the current date matching the date of presentment, parsing the check instrument data into a format prescribed by NACHA;
transmitting the parsed check instrument data to a financial institution of the first party for execution of the at least one check instrument;
determining whether the at least one check instrument has cleared the financial institution of the first party; and
transmitting funds relating to the at least one check instrument to the second party via an ACH distribution.

14. The method of claim 13, further comprising the steps of:
receiving, at the processing platform, a message indicating that the at least one check instrument failed to clear the financial institution of the first party;
determining whether the at least one check instrument was previously validated by way of using the first party identification data to access a database of records for parties that previously presented check instruments to other parties; and
distributing, from the processing platform to a financial institution of the second party, funds corresponding to the at least one check instrument responsive to determining that the deferred presentment transaction was previously validated.

15. The method of claim 14, wherein the step of determining whether the at least one check instrument was previously validated comprises receiving and analyzing information from the database of records for parties that previously presented check instruments to other parties.

16. The method of claim 13, wherein the at least one check instrument comprises first and second check instruments, and wherein the deferred presentment transaction comprises the first and second check instruments.

17. A system for use in facilitating a deferred presentment transaction between parties, the system comprising:
a network interface for:
receiving information corresponding to at least one check instrument presented by a first party to a second party as part of a deferred presentment transaction, wherein the information comprises an amount to be paid from the first party to the second party and a date of presentment of the amount; and
receiving information from a database of records for parties that have previously presented check instruments to other parties;
a storage module for storing the received information;
a processor; and
a memory module interconnected to the processor and comprising a set of computer-readable instructions that are executable by the processor to:
determine whether a current date matches the date of presentment of the at least one check instrument; and
re-determine whether the current date matches the date of presentment of the at least one check instrument responsive to the current date failing to match the date of presentment of the at least one check instrument; or
parse the at least one check instrument data into a format prescribed by NACHA and transmitting the data to a financial institution of the first party for execution of the deferred presentment transaction.
